(19) United States
(12) Patent Application Publication
(10) Pub. No.: US 2025/0262674 A1
(43) Pub. Date: Aug. 21, 2025

(54) COMPACT CLICK MECHANISM FOR A CUTTING TOOL

(71) Applicant: Kennametal Inc., Latrobe, PA (US)

(72) Inventors: Marcelo Euripedes da Silva, Piracicabo (BR); Ruy Frota de Souza Filho, Latrobe, PA (US); Patrick Kuhlemann, Fürth (DE); Eduard Ach, Moosbach (DE); Ingo Grillenberger, Neuendettelsau (DE)

(73) Assignee: Kennametal Inc., Latrobe, PA (US)

(21) Appl. No.: 18/583,177

(22) Filed: Feb. 21, 2024

(51) Int. Cl. B23B 27/16

(52) U.S. Cl. CPC B23B 27/1655

(57) ABSTRACT

A modular boring head includes a tubular main body having a slot, a movable rod engaging the tubular main body, a leadscrew disposed within the tubular main body and a compact click mechanism mounted to the leadscrew. The click mechanism includes a spur gear and an elastic latch element that acts as a bidirectional ratchet disposed radially outward with respect to the spur gear. During operation, rotation of the leadscrew causes the elastic latch element to move in an axial direction, D, within the slot and also causes the bidirectional ratchet or elastic latch element to cooperatively engage the spur gear in such a manner so as to produce an audible and tactile click, each click being indicative of a distance that the movable rod is displaced in the axial direction, D, with respect to the tubular main body.

### FIELD OF THE DISCLOSURE

The invention pertains to a click mechanism for a rotary cutting tool. More particularly, the invention relates to a compact click mechanism for a cutting tool, such as a boring bar with relatively small boring heads.

### BACKGROUND OF THE DISCLOSURE

As is generally known, boring is a mechanical process for machining surfaces of revolution carried out by one or more cutting tools. Machine tools used for performing such operations typically allow the fitting of various types of tools to permit the performance of other operations, such as drilling, milling, thread-cutting, and the like.

Depending on the position of the shaft/arbor, such machine tools may be horizontal or vertical, and the spindle may be cylindrical, conical, radial or spherical, enabling internal conical or cylindrical surfaces to be obtained in spaces that are normally difficult to access. Such machine tools may utilize axes that are perfectly parallel to one another, by means of the positioning of the machining tool by means of adjustment of the headstock to a specific height and the platen in a transverse position, all the displacements being indicated on graduated scales by means of optical reading equipment or analog/digital counters.

Therefore, for such boring operations, use is made of boring tools selected as a function of the dimensions and characteristics of the operation (i.e., length and diameter). The tools commonly have small dimensions because they operate inside bores previously made by boring bits, such as the boring bar, which, in turn, has to be rigid, cylindrical and with no rectilinearity defect, affording correct positioning on the shaft/arbor for the mounting of bushes that form bearings, thereby preventing possible deflections and vibrations.

Boring heads are widely used in fine boring operations. They usually have mechanisms to adjust the diameter due to the wear of the cutting edges. Fine boring operations are characterized by tight tolerances. Therefore, the precision of the adjustment is a very important parameter in these operations.

One common strategy for the adjustment is to provide a dial with marks. This dial can be seen on patents U.S. Pat. Nos. 3,178,969A, 3,349,648A, 3,434,376A, 3,697,187A, 4,396,319, 4,398,854A and US 20070084320A1. However, this kind of adjustment is not so accurate. Also, it is not reliable and requires some skills from the operator. Specifically, on small boring heads, the marks are very small and difficult to see, sometimes it requires the use of a magnifier, which makes the operation more difficult.

One strategy to make the adjustment more reliable an accurate is to add a click mechanism to the system. This click mechanism is usually composed by a ball (or a locating pin) and a spring, as described in US 20070084320A1, U.S. Pat. Nos. 5,326,198A, 5,316,417A, 8,602,695B2 and 10,076,790B2. However, the click mechanism used in these patents and publications cannot be applied in small boring heads due to space limitations.

Thus, it would be desirable to provide a boring head for use in a modular boring bar that overcomes the problems mentioned above.

### SUMMARY OF THE DISCLOSURE

The problem of providing a click mechanism for small boring heads is solved by providing a tubular main body with a compact click mechanism comprising a bidirectional ratchet that cooperatively engages a spur gear with external gear teeth to provide an audible and tactile click, each click being indicative of a distance a movable rod is displaced with respect to the tubular main body. The compact click mechanism can also be used in a large boring head to save space for other components.

In one aspect, a modular boring head includes a tubular main body, a movable rod engaging the tubular main body having a slot, a leadscrew disposed within the tubular main body and a compact click mechanism mounted to the leadscrew. The click mechanism includes a spur gear and an elastic latch element disposed radially outward with respect to the spur gear. During operation, rotation of the leadscrew causes the elastic latch element to move in the axial direction, D, within the slot and also causes the elastic latch element to cooperatively engage the spur gear in such a manner so as to produce an audible and tactile click, each click being indicative of a distance that the movable rod is displaced in an axial direction, D, with respect to the tubular main body.

In another aspect of the invention, a modular boring head includes a tubular main body having a slot, a movable rod engaging the tubular main body, a leadscrew disposed within the tubular main body and a compact click mechanism mounted to the leadscrew. The click mechanism includes a spur gear and a bidirectional ratchet disposed radially outward with respect to the spur gear. During operation, rotation of the leadscrew causes the elastic latch element to move in the axial direction, D, within the slot and also causes the bidirectional ratchet to cooperatively engage the spur gear in such a manner so as to produce an audible and tactile click, each click being indicative of a distance that the movable rod is displaced in an axial direction, D, with respect to the tubular main body.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a side view of a modular boring head with a compact click mechanism in accordance with an embodiment of the disclosure;

FIG. 2 is an exploded view of the modular boring head of FIG. 1;

FIG. 3 is a bottom view of the modular boring head of FIG. 1;

FIG. 4 is a cross-sectional view of the modular boring head taken along line 4-4 of FIG. 3;

FIG. 5 is a bottom perspective view of the main tubular body of the modular boring head of FIG. 1;

FIG. 6 is a side perspective view of the leadscrew of the modular boring head of FIG. 1 with the compact click mechanism mounted thereon;

FIG. 7 is an exploded view of the compact click mechanism including a spur gear and an elastic latch element that acts as a bidirectional ratchet according with an embodiment of the disclosure;

FIG. 8 is cross-sectional view of the compact click mechanism taken along line 8-8 of FIG. 1; and

FIG. 9 is top view of the compact click mechanism of FIG. 7.

### DETAILED DESCRIPTION OF THE DISCLOSURE

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, a “leadscrew” or “lead screw”, also known as a “power screw” or “translation screw”, is a screw used to translate turning motion into linear motion.

As used herein, a “gear” is a rotating circular machine part having cut teeth or, in the case of a cogwheel or gearwheel, inserted teeth (called cogs), which mesh with another (compatible) toothed part to transmit (convert) torque and speed. A gear may also be known as a cog.

As used herein, a “spur gear” or “straight-cut gears” comprise a cylinder or disk with teeth projecting radially. Viewing the gear at 90 degrees from the shaft length (side on), the tooth faces are straight and aligned parallel to the axis of rotation. Spur gears can be classified into two main categories: External and Internal. Gears with teeth on the outside of the cylinder are known as “external gears”. Gears with teeth on the internal side of the cylinder are known as “internal gears”.

As used herein, an “elastic element” is an object or material that is able to resume its normal shape spontaneously after contraction, dilatation, or distortion.

As used herein, a “pawl” is a pivoted curved bar or lever whose free end engages with the teeth of a cogwheel or ratchet so that the cog wheel or ratchet can only turn or move one way.

A bi-directional ratchet (occasionally spelled rachet) is a mechanical device that allows continuous linear or rotary motion in both the forward and reverse direction, unlike a unidirectional ratchet that allows continuous linear or rotary motion in only one direction while preventing motion in the opposite direction.

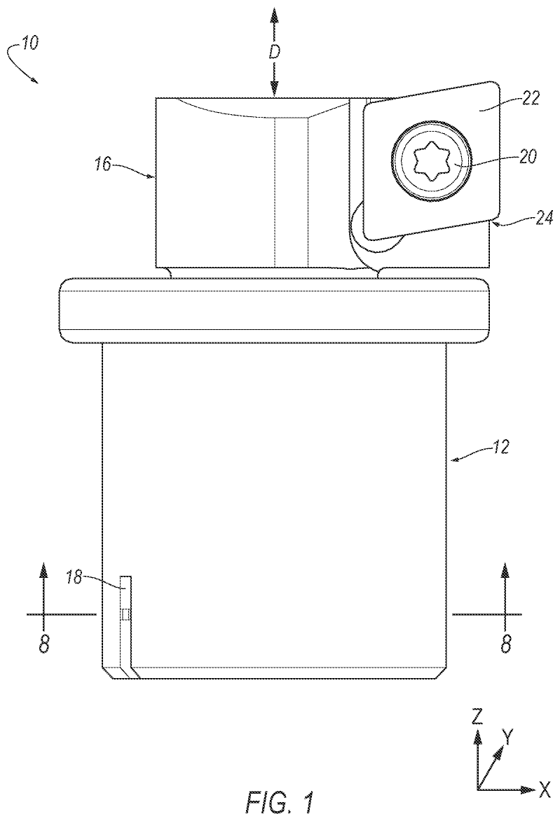

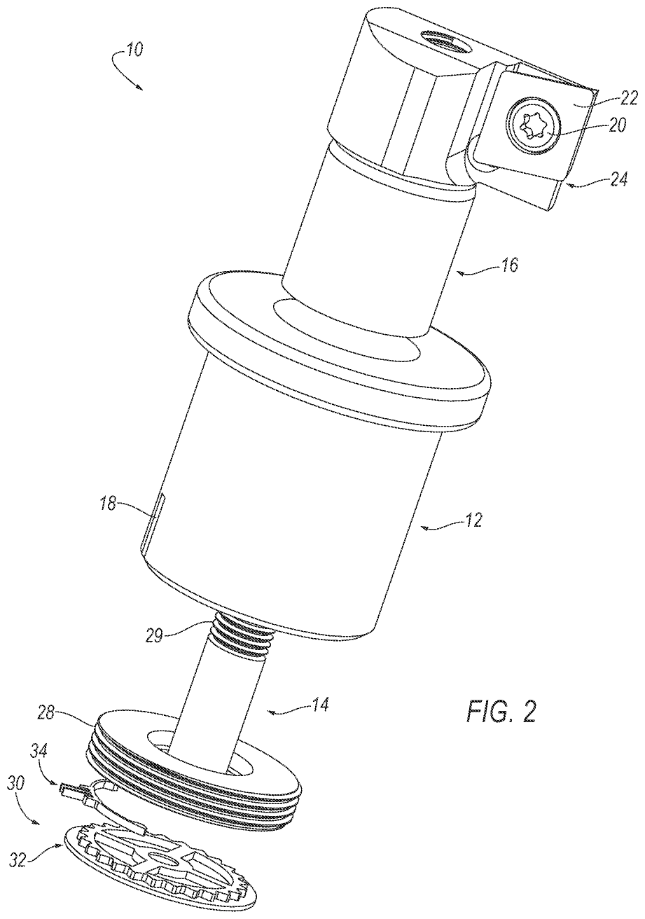

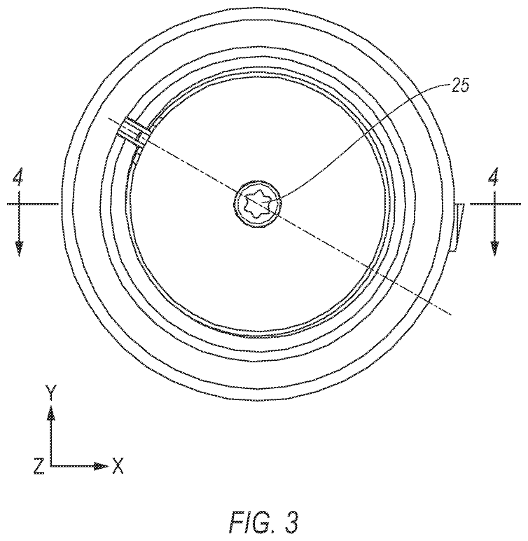

Referring now to FIGS. 1-3, a modular boring head 10 is shown according to an embodiment of the disclosure. The modular boring head 10 is used in a rotary cutting tool, such as a boring bar, and the like. It should be appreciated that the modular boring head 10 is not limited to use in a boring bar, and that the principles of the disclosure can be used in other rotary cutting tools.

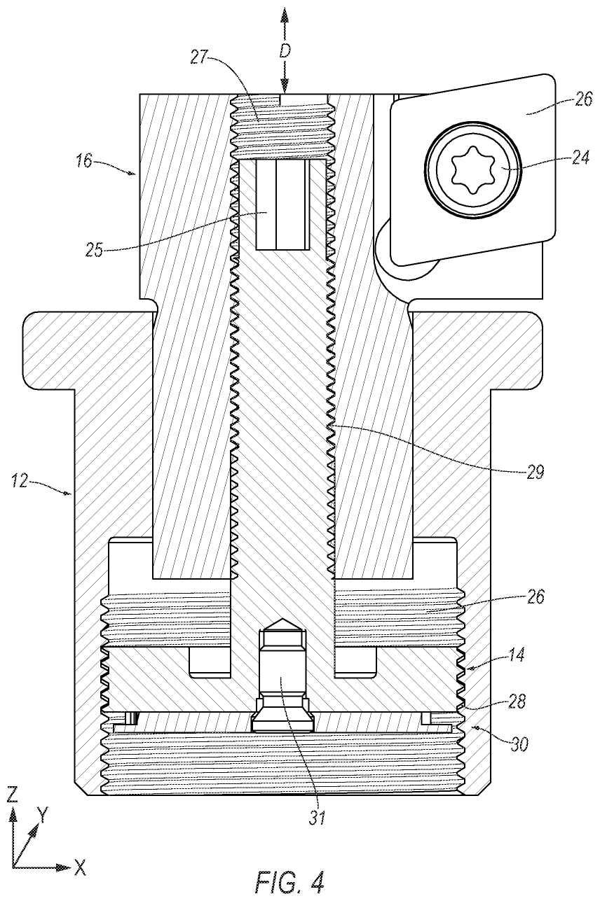

In general, the modular boring head 10 comprises a tubular main body 12, which is usually made of steel, and a leadscrew 14 disposed within the tubular main body 12, also usually made of steel. The boring head 10 also includes a movable rod 16, usually made of steel, which moves in an axial direction (i.e., parallel to the z-axis) relative to the tubular main body 12. The tubular body 12 includes an axially elongated slot 18 in the tubular main body 12 to cooperate with the compact click mechanism 30, as described below. It should be understood that rotation of the leadscrew 14 causes movement of the movable rod 16 by a distance in the axial direction, D, indicated by the arrows shown in FIGS. 1 and 4. A mounting screw 20 is used to clamp a cutting insert 22 in a pocket 24 of the movable rod 16.

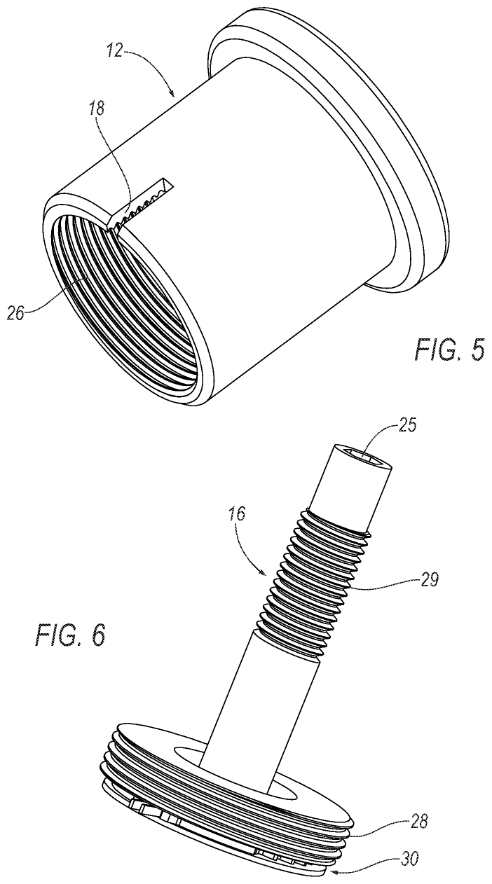

Axial adjustment of the movable rod 16 and the cutting insert 26 by a desired distance in the axial direction (i.e., parallel to the z-axis) is accomplished by rotating the leadscrew 14 with the use of a tool, such as an Allen® wrench, a Torx® wrench, and the like, that engages a recess 25, located at one end of the leadscrew 14. As shown in FIGS. 4 and 5, the tubular main body 12 and the movable rod 16 have internal threads 26, 27, respectively, with different pitches. As shown in FIGS. 4 and 6, the leadscrew 14 has external threads 28, 29 with different pitches that cooperatively engage the internal thread 26 of the tubular main body 12 and the internal thread 27 of the movable rod 16, respectively. In the illustrated embodiment, the external threads 28 of the leadscrew 14 that cooperatively engage with the internal threads 26 of the tubular main body 12 have a larger diameter than the external threads 29 of the leadscrew 14 that cooperatively engage with the internal threads 27 of the movable rod 16.

One aspect of the disclosure is that the modular boring head 10 includes a compact click mechanism, shown generally at 30, that provides an audible and tactile feedback to the operator during the fine adjustment of the modular boring head 10. As shown in FIG. 4, the compact click mechanism 30 is mounted to the leadscrew 14 by using a threaded fastener 31, such as a bolt, and the like. In the illustrated embodiment, the compact click mechanism 30 is mounted to the bottom surface of the leadscrew 14.

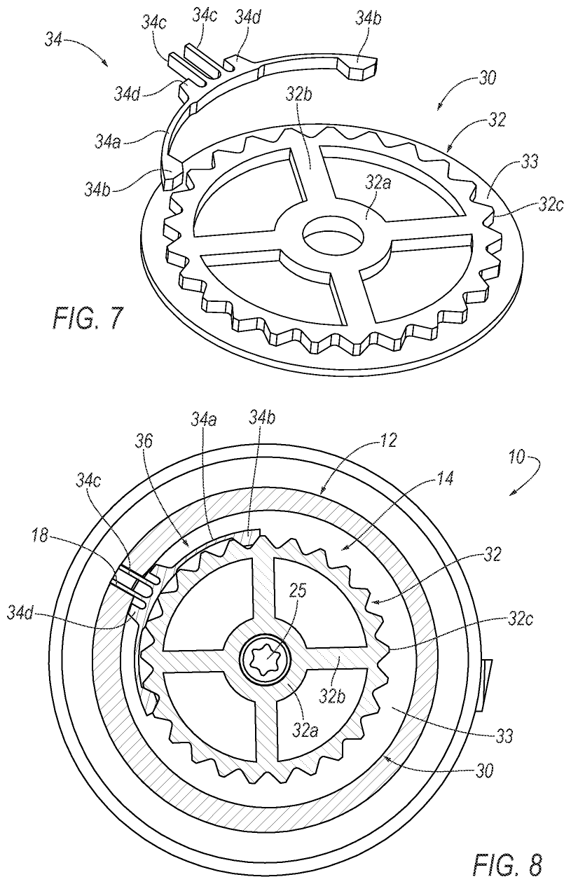

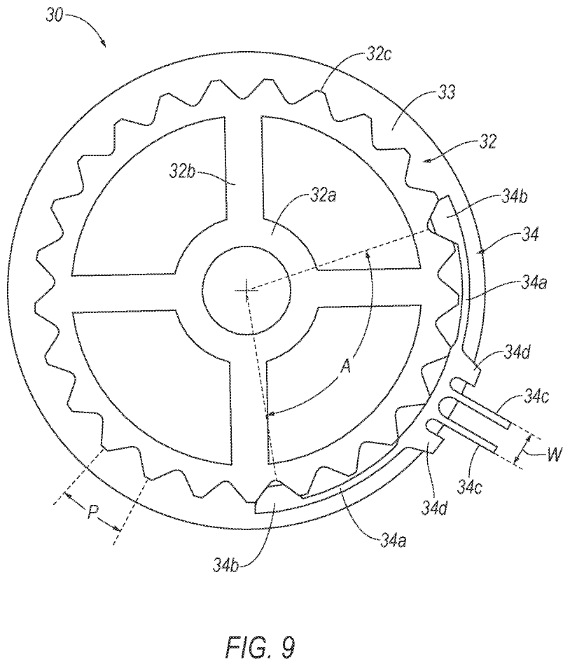

Referring now to FIGS. 7-9, the compact click mechanism 30 comprises a spur gear 32, a support disc 33 for supporting the spur gear 32, and an elastic latch element 34 disposed radially outward with respect to the spur gear 32 that acts as a bidirectional ratchet. In the illustrated embodiment, the bidirectional ratchet or elastic latch element 34 is supported by the support disc 33 of the spur gear 32. The spur gear 32 has a hub 32a, a plurality of spokes 32b extending radially outward from the hub 32a, and a plurality of external teeth 32c. In the illustrated embodiment, for example, the leadscrew 14 has a total of twenty-five external teeth 32c. Thus, the gear teeth 32c are spaced apart at a pitch, P, of about 14.4 degrees (360 degrees/25=14.4 degrees). It should be noted that the spur gear 32 rotates with the leadscrew 14 during operation.

The elastic latch element 34 includes a pair of curved arms 34a with a latch tooth 34b at the end of each arm 34a. The arms 34a have a radius of curvature approximately equal to the radius of curvature of the teeth 32c of the spur gear 32. The arms 34a act as a pawl and are made of a suitable material, such as metal, and the like, to allow the arms 34a to elastically deform in the radial direction (i.e., radially outward from the hub 32a) during operation.

A pair of prongs 34c are centrally located between the arms 34a. The prongs 34c are disposed within the slot 18 of the tubular main body 12 provides an anti-rotation feature that prevents rotation of the elastic latch element 34 but allows movement of the elastic latch element 34 in the axial direction, D, during operation. To compensate for manufacturing tolerances, the width, W, between each the outer surfaces of the prongs 34c may be slightly larger than the width of the slot 18 to assure that the elastic latch element 34 is rigidly affixed to prevent rotation during operation.

The elastic latch element 34 further includes a thread engagement member 34d adjacent each of the prongs 34c. The thread engagement member 34d engages the internal threads 26 of the tubular main body 12 to prevent disengagement of the latch tooth 34b of the elastic latch element 34 with the at least one of the plurality of gear teeth 32c of the spur gear 32. As a result, prevent radial movement (i.e., perpendicular to the axial direction, D, of the elastic latch element 34 when the leadscrew 14 is rotated during operation. As a result, the thread engagement member 34d prevents radial movement (i.e., perpendicular to the axial direction, D, of the elastic latch element 34 when the leadscrew 14 is rotated during operation.

As mentioned above, in the illustrated embodiment, the gear teeth 32b are spaced apart at a pitch, P, of about 14.4 degrees (360 degrees/25=14.4 degrees). In the illustrated embodiment, there are seven gear teeth 32b between the pair of latch teeth 34b of the elastic latch element 34. In the illustrated embodiment, the latch teeth 34b of the elastic latch element 34 are offset from each other by the angle, A, of about 100.8 degrees (7×14.4 degrees). However, it will be appreciated that the invention is not limited by the number of gear teeth 32b disposed between the latch teeth 34b, and that the invention can be practiced with any desirable number of gear teeth 32b disposed between the latch teeth 34b, so long as there is an adequate ‘click’ when the latch teeth 34b of the elastic latch element 34 engage the gear teeth 32c of the spur gear 32.

The engagement of the latch teeth 34b of the elastic latch element 34 with the gear teeth 32c of the spur gear 32 provides a defined stop to rotate the leadscrew 14. Therefore, the operator can control the rotation of the leadscrew 14 by feeling the engagement and disengagement of the teeth gear 32c of the spur gear 32 with the latch teeth 34b of the elastic latch element 34. It will be appreciated that the invention is not limited by the number of gear teeth 32c, and the invention can be practiced with any desirable number of gear teeth 32c, depending on the quality of the audible and tactile feedback provided by the click mechanism.

In operation, when the gear teeth 32c of the spur gear 32 rotates, the elastic latch element 34 remains stationary relative to the spur gear 32 and the latch teeth 34b of the elastic latch element 34 easily slides up the gently sloped edges of the gear teeth 32c until the engagement is released. Then, when the spur gear 32 is further rotated, the latch teeth 34b engage the next gear tooth 32c with a biasing force of the arms 34a in the radially inward direction forcing the latch teeth 34b into the valley of the next gear tooth 32c, thereby providing an audible ‘click’ to the operator.

As described above, the compact click mechanism has several advantages, which are:
(1) The click mechanism is compact and small, so it can be added to small boring heads, which at the current state of the art, have only a small dial, which is difficult rotate in a precise way.
(2) The click mechanism provides a defined stop during the rotation of the main screw which is responsible for the tool adjustment. The operator can feel and hear the “click”. In the disclosure, the leadscrew 14 is only an example of a type of screw that can be used to adjust the tool.
(3) There are only two main components in the mechanism, which makes the manufacturing easy and inexpensive.
(4) The elastic element can be rigid fixed to the body against rotation, through elastic surfaces. At the same time, the elastic element is allowed to move axially, which is very different from the conventional click mechanisms, which stay completely stationary.
(5) The mechanism presented in this invention can also be used in larger boring heads, to save space for other components, or even to allow a design simplification, which is also beneficial to reduce costs.

The patents and publications referred to herein are hereby incorporated by reference.

Having described presently preferred embodiments the invention may be otherwise embodied within the scope of the appended claims.

What is claimed is:

1. A modular boring head, comprising:
a tubular main body having a slot;
a movable rod engaging the tubular main body such that the movable rod moves in an axial direction, D, with respect to the tubular main body;
a leadscrew disposed within the tubular main body; and
a click mechanism mounted to the leadscrew, the click mechanism comprising a spur gear and an elastic latch element disposed radially outward with respect to the spur gear,
wherein rotation of the leadscrew causes the elastic latch element to move in the axial direction, D, within the slot, and
wherein rotation of the leadscrew causes the elastic latch element to cooperatively engage the spur gear in such a manner so as to produce an audible and tactile click, each click being indicative of a distance that the movable rod is displaced in the axial direction, D, with respect to the tubular main body.

2. The modular boring head of claim 1, wherein, the spur gear includes a central hub, a plurality of spokes extending radially outward from the hub, and a plurality of external gear teeth.

3. The modular boring head of claim 2, wherein the spur gear has twenty-five gear teeth, and wherein the gear teeth are spaced apart at a pitch, P, of about 14.4 degrees from each other.

4. The modular boring head of claim 2, wherein the elastic latch element includes a pair of curved arms with a latch tooth at the end of each arm that cooperatively engage with at least one of the plurality of gear teeth of the spur gear to produce the audible and tactile click during operation.

5. The modular boring head of claim 4, wherein the elastic latch element further includes a pair of prongs disposed within a slot of the tubular main body that prevents rotation of the spur gear but allows movement of the elastic latch element in the axial direction, D, during operation.

6. The modular boring head of claim 5, wherein the elastic latch element further includes a thread engagement member for engaging an internal thread of the tubular main body to prevent disengagement of the latch tooth of the elastic latch element with the at least one of the plurality of gear teeth of the spur gear.

7. The modular boring head of claim 1, wherein the leadscrew has a first external thread with a first pitch and a second external thread with a second, different pitch.

8. The modular boring head of claim 7, wherein the distance the moveable rod is displaced in the axial direction, D, is a function of the difference in pitch between the first external thread and the second external thread of the leadscrew.

9. The modular boring head of claim 8, wherein the first external thread (28) of the leadscrew (14) has a larger diameter than the second external thread (29) of the leadscrew.

10. A modular boring head, comprising:
a tubular main body having a slot;
a movable rod engaging the tubular main body such that the movable rod moves in an axial direction, D, with respect to the tubular main body;
a leadscrew disposed within the tubular main body; and
a click mechanism mounted to the leadscrew, the click mechanism comprising a spur gear and a bidirectional ratchet disposed radially outward with respect to the spur gear and supported by a support disc,
wherein rotation of the leadscrew causes the elastic latch element (34) to move in the axial direction, D, within the slot, and
wherein rotation of the leadscrew causes the bidirectional ratchet to cooperatively engage the spur gear in such a manner so as to produce an audible and tactile click, each click being indicative of a distance that the movable rod is displaced in the axial direction, D, with respect to the tubular main body.

11. The modular boring head of claim 10, wherein, the spur gear includes a central hub, a plurality of spokes extending radially outward from the hub and a plurality of external gear teeth.

12. The modular boring head of claim 11, wherein the spur gear has twenty-five gear teeth, and wherein the gear teeth are spaced apart at a pitch, P, of about 14.4 degrees from each other.

13. The modular boring head of claim 11, wherein the bidirectional ratchet includes a pair of curved arms with a latch tooth at the end of each arm that cooperatively engage the plurality of gear teeth of the spur gear to produce the audible and tactile click during operation.

14. The modular boring head of claim 13, wherein the bidirectional ratchet further includes a pair of prongs disposed within a slot of the tubular main body that prevents rotation of the spur gear but allows movement of the bidirectional ratchet in the axial direction, D, during operation.

15. The modular boring head of claim 14, wherein the bidirectional ratchet further includes a thread engagement member) for engaging an internal thread of the tubular main body to prevent disengagement of the latch tooth of the elastic latch element with the at least one of the plurality of gear teeth of the spur gear.

16. The modular boring head of claim 10, wherein the leadscrew has a first external thread with a first pitch and a second external thread with a second, different pitch.

17. The modular boring head of claim 16, wherein the distance the moveable rod is displaced in the axial direction, D, is a function of the difference in pitch between the first external thread and the second external thread of the leadscrew.

18. The modular boring head of claim 17, wherein the first external thread of the leadscrew has a larger diameter than the second external thread of the leadscrew.
